(19) United States
(12) Patent Application Publication
(10) Pub. No.: US 2019/0256321 A1
(43) Pub. Date: Aug. 22, 2019

(54) BRAKING DEVICE FOR AN ELEVATOR SYSTEM

(71) Applicants: thyssenkrupp Elevator AG, Essen (DE); thyssenkrupp AG, Essen (DE)

(72) Inventor: Markan LOVRIC, Stuttgart (DE)

(73) Assignees: thyssenkrupp Elevator AG, Essen (DE); thyssenkrupp AG, Essen (DE)

(21) Appl. No.: 16/333,683

(22) PCT Filed: Sep. 11, 2017
(86) PCT No.: PCT/EP2017/072681

§ 371 Date: Mar. 15, 2019

(30) Foreign Application Priority Data
Sep. 16, 2016 (DE) 10 2016 217 790.7

(51) Int. Cl. B66B 1/32; B66B 1/50; B66B 1/34

(52) U.S. Cl. CPC B66B 1/32; B66B 2009/006; B66B 1/3476; B66B 1/50

(57) ABSTRACT

A braking device may be utilized by an elevator system that has a cabin that is movable within an elevator shaft. The braking device may comprise an actuator and a brake. The actuator may be configured to provide an actuating force for the brake as needed. The braking device may include a force measuring assembly for generating a load state value of the cabin. The force measuring assembly may be mechanically coupled to the actuator such that the actuating force is dependent on the load state value. The actuator may be configured such that the greater the load state value the greater the actuating force.

The invention relates to a braking device for an elevator system, an elevator system as well as a method for setting an actuating force of a braking device.

With conventional traction elevators the cabin is prevented from crashing, for example the traction rope breaking, by a catching device. In most cases the braking force of the catching device is set to be the mean payload of the elevator system. It is only when the cabin load is equal to the mean payload, that an optimal delay of the cabin results. If the payload is higher than the mean payload, the catching device delays the cabin less, which leads to the braking distance becoming longer. If the payload is less than the mean payload, the catching device delays the cabin faster and the load on components of the cabin increases. This can lead to damage of the elevator system and the danger of injury to the passengers increases.

WO 2016 071141 A1 discloses an elevator with a braking device. The braking device is designed to be used, on the one hand, as an operating brake, and on the other, as a catching device. The braking force available differs according to the intended use.

EP 1 657 203 A2 has disclosed a catching device for an elevator. The braking force progression is arranged such, that the maximum braking force acting on the cabin is higher for a fully loaded cabin than for a partially loaded cabin. This is achieved by causing the braking force to increase in a ramp-like fashion. If the cabin is not fully loaded, the cabin comes to a standstill, before the maximum braking force has been completely reached. This means however, if the argument is reversed, that for a fully loaded cabin the maximum braking force acts on the cabin at a comparatively late stage, so that the braking distance for a fully loaded cabin is comparatively large.

It is the objective of the invention to improve the braking system for elevator systems, in particular it shall be ensured that the delay of the cabin and the braking distance are optimal in all load states.

This objective is achieved through a braking device, an elevator system and a method with the characteristics cited in the independent claims. Advantageous further developments are revealed in the sub-claims, the description hereunder and the figures. The advantages and design options described for the braking device and the elevator system are applicable without further ado to the method and vice-versa.

The braking device according to the invention is suitable for an elevator system, which comprises a movable cabin inside an elevator shaft. The braking device comprises an actuator and a brake. The actuator is configured to provide an actuating force for the brake when needed. The braking device comprises a force measuring assembly for producing a load state value of the cabin. The force measuring assembly is mechanically coupled to the actuator such that the actuating force is dependent on the load state value.

The term mechanical coupling comprises expressly a fluid-mechanical coupling, for example by means of a hydraulic or pneumatic line. Alternatively or in combination hoists or levers can be used as a mechanical coupling. The load state value may basically be a value, which largely correctly reflects the load on the cabin in a static state. Falsifying dynamic measuring influences, if any, can be filtered.

The actuating device according to the invention makes it possible for the actuating force to be optimally matched to the load. The greater the load or the load state value, the greater the actuating force may be. This makes it possible in any load state for the braking distance and/or the delay to assume a desired value when needed. There is no longer any need for an expensive electronic control of the actuating force, which takes account of the load state. In particular, the braking device therefore does not comprise an electronic control for the actuating force which takes account of the load state.

Preferably the force measuring assembly comprises at least one, in particular at least three, load cells, which are configured to together detect a weight force of the cabin. The weight force or weight forces detected do not need to be the total of all weight forces of the cabin. Rather it may suffice to arrange the load cells underneath the cabin floor, for example, so that parts of the floor can be detected including the load acting on them. The force measuring assembly is configured to generate the load state value from the detected weight force (including any plurality of weight forces detected).

Preferably the force measuring assembly comprises a low pass filter, which is arranged to filter dynamic influences of a primary value of the load state value. The load state values detected by the at least one load cell can be falsified by accelerations of the cabin. Influences due to these dynamic effects can be at least reduced by using the filter.

Preferably the braking device comprises a stop for limiting the influence of the load state value on the actuating force. In this way it is possible to limit the influence from extreme, in particular unrealistic load state values. Such extreme load state values can be caused by defects or extreme dynamic influences.

Preferably the actuator comprises a force capacity for providing the actuating force. The actuator is configured so as to set a preload for the force capacity as a function of the load state value. The greater the preload, the greater is also at least the initial actuating force.

Preferably the actuator is designed such that, when in a standby mode, the force capacity is held against the actuating force in a standby position in which no actuating force is applied to the brake, and when in actuating mode, the force capacity is not held in the standby position and the actuating force is applied to the brake.

Preferably the force measuring assembly is arranged to pass the load state value onto the actuator by means of a pressurized fluid, with the actuator being arranged in particular such that the fluid preloads the force memory or at least increases a preload.

The method according to the invention comprises the following method steps: generating a load state value of the cabin by way of the force measuring assembly, communicating the load state value from the force measuring assembly via a mechanical coupling to the actuator, setting the actuating force as a function of the communicated load state value.

The invention is suitable, in particular, for applications with braking devices in the form of catching devices. Essentially, with such catching devices an at least temporarily pre-set actuating force is fully retrieved when needed. The present invention makes it possible to adjust the amount of actuating force to be fully retrieved to match the load state.

The invention will now be explained in detail with reference to the figures, in which in each case

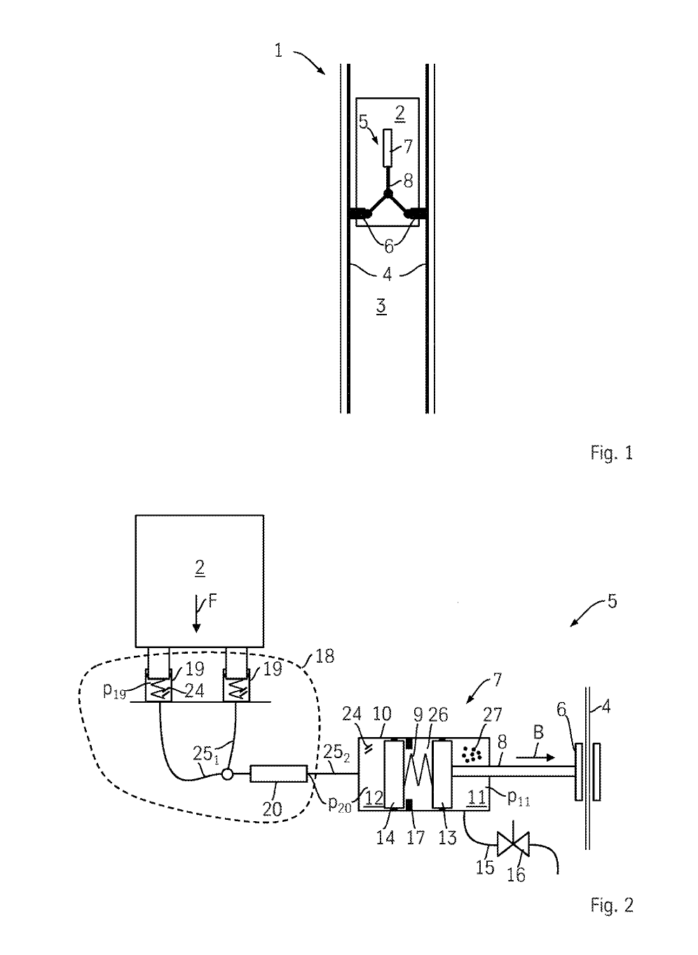

FIG. 1 schematically shows an inventive elevator system, which comprises a braking device according to the invention;

FIG. 2 schematically shows the components of the braking device of the elevator system of FIG. 1;

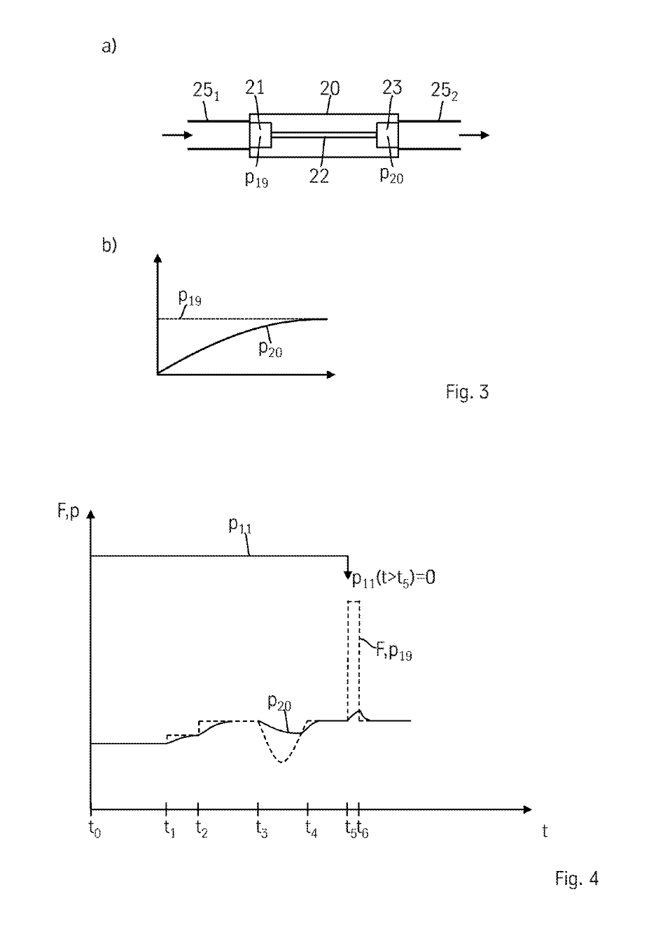

FIG. 3 a) schematically shows a throttle unit of the braking device of FIG. 2,
b) shows the step response diagram associated with the throttle unit.

FIG. 4 schematically shows the progression of selected pressure and force values during operation.

FIG. 1 shows an elevator system 1 according to the invention, which comprises a cabin 2 which is received within an elevator shaft 3. The cabin 2 is held vertically movably in guide rails 4 by means of guide rollers not shown. The elevator system 1 further comprises a braking device 5 with at least one brake 6. In case of a defect one or more such brakes 6 can be activated. The braking device 5 comprises an actuator 7 which provides a braking force when needed. The braking force is transferred to the brakes 6 via a connector 8.

FIG. 2 shows the braking device 5 in more detail. The braking device accordingly comprises three essential components, i.e. the brake 6, the actuator 7 and a force measuring assembly 18.

The brake 6 when actuated starts to interact with the guide rail 4 in order to thereby at least reduce the speed of the cabin 2, in particular to bring the cabin to a standstill. The actuator 7 actuates the brake 6. In doing so the actuator 7 generates an actuating force B when needed, as a result of which the brake 6 starts to interact with the rail 4.

In the present example the actuator comprises an actuating cylinder 10, in which a first working piston 13 is arranged. On the one hand this first working piston 13 is impacted by a spring 9, which is dimensioned so as to apply the actuating force B. On the other hand the first working piston 13 is held back by a pneumatic medium 27 (e.g. air) present in a first working chamber 11 at a pneumatic pressure p₁₁ in a standby state. The pneumatic pressure p₁₁ counteracts the spring 9, so that the actuator cannot apply the actuating force B to the brake 6. When needed a vent valve 16 is opened and the pneumatic pressure p₁₁ can escape from the first working chamber 11. The actuating force B which can be generated by the force capacity 9, can now be transferred via the connector 8 to the brake 6. A clearance 26 between the two working pistons 13, 14 can be impacted by environmental pressure.

The force capacity 9 is preloaded by a second working piston 14, which is also arranged in the actuating cylinder. Counteracting the spring 9 is a second working chamber 12 arranged on the other side of the second working piston 14, and this working chamber 12 contains a hydraulic oil 24. The hydraulic oil 24 is pressurized by load cells 19, which are connected via a hydraulic connection 25 to the second working chamber 12. The load cells are arranged below the cabin 2 and are impacted according to the load of the cabin 2 including the cabin content. Depending on the weight of the cabin a primary pressure p₁₉ is generated by the load cells 19, which equally represents an unfiltered hydraulic pressure value. Preferably at least three load cells 19 are provided for support the cabin floor without tilting.

A low pass filter 20, here in the form of a throttle, is arranged in the hydraulic connection 25 between the load cells 19 and the second working chamber 12. An example of a throttle is shown in detail in FIG. 3a, and the associated step response diagram is shown in FIG. 3b. The low pass filter 20 comprises an inlet 21, which is connected via a first line 251 to the load cell 19. At the inlet 21 the hydraulic primary pressure p₁₉ is present, which is provided by the load cells 19. The inlet 21 is connected to an outlet 23 via a throttle point 22 with reduced line cross-section, which in turn is connected via a second line 252 to the second working chamber 12. The secondary pressure p₂₀ present at the outlet 23 which simultaneously represents a filtered hydraulic pressure value, is also present in the second working chamber 12 and has a major impact on the preload force for the spring 9. The second line 252 represents the coupling between the force measuring assembly 18 and the actuator 7.

The importance of the low pass filter 20 is explained by way of the diagram in FIG. 4. The diagram shows the progression of the primary pressure p₁₉ and the secondary pressure p₂₀. The progression of the secondary pressure p₂₀ is shown by a continuous line. At the point where the progression of the primary pressure p₁₉ is different from the progression of the secondary pressure p₂₀, the diagram shows the progression of the primary pressure p₁₉ in the form of a dotted line. The progression of the primary pressure p₁₉ is essentially identical to a cabin load F, which impacts the load cells 19 from above. In addition the pneumatic pressure p₁₁ in the first working chamber 11 is shown at the top.

At the point in time t₀ the cabin 2 is stationary on one floor. The doors open. At the point in time t₁ a first person boards, at the point in time t₂ a second person boards. Boarding of the persons is depicted by a step each in the progression of the primary pressure p₁₉. Due to the inertia of the filter 20 the progression of the secondary pressure p₂₀ is delayed in terms of time. The doors close and the cabin 2 moves downwards. Due to the downward acceleration the load on the load cells 19 is reduced, the primary pressure p₁₉ drops temporarily. Again the progression of the secondary pressure p₂₀ is delayed in terms of time. As from point in time t4 the cabin 2 descends at a constant speed.

At the point in time t₅ emergency braking is initiated by opening of the valve 16, with no pneumatic pressure p₁₁ present. Immediately afterwards the brake 6 is activated and braking of the cabin 2 is complete as soon as point in time t₆ is reached. Due to massive acceleration during the braking operation primary pressure p₁₉ temporarily rises. Due to the progression of the primary pressure p₁₉ it can be seen that the dynamic primary pressure p₁₉ is not sufficiently representative of the load state of the cabin.

Although the secondary pressure p₂₀ follows the progression of the primary pressure p₁₉, the progression is substantially attenuated. In particular during the braking operation in the period between t₅ and t₆ the secondary pressure p₂₀ represents a value, which maps the actual load state substantially better than the primary pressure p₁₉. Due to a suitable selection of the filter parameters the progression of the secondary pressure p₂₀ can be optimized during the braking operation.

### LIST OF REFERENCE SYMBOLS

1 elevator system
2 cabin
3 elevator shaft
4 guide rails
5 braking device
6 brake
7 actuator
8 connector
9 preload spring
10 actuating cylinder
11 first working chamber (pneumatic chamber)
12 second working chamber (hydraulic chamber)
13 first working piston
14 second working piston
15 vent line
16 vent valve
17 stop
18 force measuring assembly
19 load cell
20 throttle unit
21 inlet
22 throttle piece
23 outlet
24 hydraulic oil
25 hydraulic line
26 clearance
27 pneumatic medium
P₁₉ unfiltered hydraulic pressure value
p₂₀ filtered hydraulic pressure value
P₁₁ pneumatic pressure valve
F cabin load
B actuating force

1.-10. (canceled)

11. A braking device for an elevator system with a cabin that is movable inside an elevator shaft, the braking device comprising:
a brake;
an actuator configured to provide an actuating force for the brake; and
a force measuring assembly for generating a load state value of the cabin, wherein the force measuring assembly is mechanically coupled to the actuator such that the actuating force is dependent on a load state value.

12. The braking device of claim 11 wherein the actuator is configured such that the greater the load state value the greater the actuating force.

13. The braking device of claim 11 wherein the force measuring assembly comprises a load cell that is adapted to detect a weight force of the cabin, wherein the force measuring assembly is configured to generate the load state value from the weight force.

14. The braking device of claim 11 wherein the force measuring assembly comprises at least three load cells that are adapted to detect a weight force of the cabin, wherein the force measuring assembly is configured to generate the load state value from the weight force.

15. The braking device of claim 11 wherein the force measuring assembly comprises a low pass filter adapted to filter dynamic influences out of a primary value of the load state value.

16. The braking device of claim 11 comprising a stop for limiting an influence of the load state value on the actuating force.

17. The braking device of claim 11 wherein the actuator comprises a force capacity for providing the actuating force, the actuator being configured such that a preload of the force capacity is set as a function of the load state value.

18. The braking device of claim 17 wherein the actuator is configured such that in a standby mode the force capacity is held in a standby position against the actuating force, wherein in the standby position the actuating force is not applied to the brake, wherein in an operating mode the force capacity is not held in the standby position and the actuating force is applied to the brake.

19. The braking device of claim 17 wherein the force measuring assembly is configured to pass the load state value on to the actuator by way of a pressurized fluid.

20. The braking device of claim 19 wherein the actuator is configured for the pressurized fluid to preload the force capacity or at least to increase a preload of the force capacity.

21. A method for setting an actuating force of the braking device of claim 11, the method comprising:
generating the load state value of the cabin by way of the force measuring assembly;
communicating the load state value from the force measuring assembly to the actuator via a mechanical coupling; and
setting the actuating force depending on the communicated load state value.

22. An elevator system comprising:
a cabin that is movable inside an elevator shaft; and
a braking device comprising
a brake,
an actuator configured to provide an actuating force for the brake, and
a force measuring assembly for generating a load state value of the cabin, wherein the force measuring assembly is mechanically coupled to the actuator such that the actuating force is dependent on a load state value.

23. The elevator system of claim 22 wherein the actuator is configured such that the greater the load state value the greater the actuating force.

24. The elevator system of claim 22 wherein the force measuring assembly comprises a load cell that is adapted to detect a weight force of the cabin, wherein the force measuring assembly is configured to generate the load state value from the weight force.

25. The elevator system of claim 22 wherein the force measuring assembly comprises at least three load cells that are adapted to detect a weight force of the cabin, wherein the force measuring assembly is configured to generate the load state value from the weight force.

26. The elevator system of claim 22 wherein the force measuring assembly comprises a low pass filter adapted to filter dynamic influences out of a primary value of the load state value.

27. The elevator system of claim 22 comprising a stop for limiting an influence of the load state value on the actuating force.

28. The elevator system of claim 22 wherein the actuator comprises a force capacity for providing the actuating force, the actuator being configured such that a preload of the force capacity is set as a function of the load state value.

29. The elevator system of claim 28 wherein the actuator is configured such that in a standby mode the force capacity is held in a standby position against the actuating force, wherein in the standby position the actuating force is not applied to the brake, wherein in an operating mode the force capacity is not held in the standby position and the actuating force is applied to the brake.

30. The elevator system of claim 28 wherein the force measuring assembly is configured to pass the load state value on to the actuator by way of a pressurized fluid.
